(19) United States
(12) Patent Application Publication
(10) Pub. No.: US 2011/0199182 A1
(43) Pub. Date: Aug. 18, 2011

(54) SENSOR ACTUATED STORAGE COMPARTMENT

(75) Inventor: Michael Catlin, Holland, MI (US)

(73) Assignee: JOHNSON CONTROLS TECHNOLOGY COMPANY, HOLLAND, MI (US)

(21) Appl. No.: 13/123,198

(22) PCT Filed: Oct. 8, 2009
(86) PCT No.: PCT/US09/60027

§ 371 Date: Apr. 7, 2011

Related U.S. Application Data
(60) Provisional application No. 61/103,827, filed on Oct. 8, 2008.

(51) Int. Cl. G05B 19/00

(52) U.S. Cl. 340/5.7

(57) ABSTRACT

A storage compartment is provided that includes a sensor configured to generate a signal based on presence of an activating object. The storage compartment also includes a controller communicatively coupled to the sensor and configured to detect an object adjacent to the storage compartment based on the signal. The storage compartment further includes an actuator communicatively coupled to the controller and configured to release a securing feature of the storage compartment when the controller detects the object adjacent to the storage compartment.

### CROSS REFERENCE TO RELATED APPLICATION

This application claims priority from and the benefit of U.S. Provisional Application Ser. No. 61/103,827, entitled “STORAGE BIN WITH FIELD EFFECT ACTUATION”, filed Oct. 8, 2008, which is hereby incorporated by reference in its entirety.

### BACKGROUND

The invention relates generally to a sensor actuated storage compartment.

Storage compartments may be positioned throughout an interior of a vehicle to store cargo and other small items. For example, an overhead console may include a storage compartment suitable for storing sunglasses, driving glasses, or other similar items. Other storage compartments may be located within a center console, an armrest, seats, door panels, or other areas of the vehicle interior. Certain storage compartments, i.e., cup holders, may be particularly configured to secure beverage containers. These cup holders may be positioned within easy reach of vehicle occupants, and shaped to accommodate various beverage container sizes.

Certain storage compartments include a door configured to secure the contents of the compartment and/or hide the contents from view of the vehicle occupants. For example, the storage compartment within the overhead console may include a rotatable door having a pocket configured to secure an item such as sunglasses. To access the item, an occupant may manually rotate the door and/or engage a release mechanism to facilitate door rotation. After the item has been removed, the occupant may manually close the door. As will be appreciated, such manual door operation may cause undesirable distraction for a driver operating the vehicle.

### BRIEF DESCRIPTION OF THE INVENTION

The present invention relates to a storage compartment including a sensor configured to generate a signal based on presence of an activating object. The storage compartment also includes a controller communicatively coupled to the sensor and configured to detect an object adjacent to the storage compartment based on the signal. The storage compartment further includes an actuator communicatively coupled to the controller and configured to release a securing feature of the storage compartment when the controller detects the object adjacent to the storage compartment.

The present invention also relates to a storage compartment including a door configured to substantially enclose the storage compartment while in an engaged position, and to facilitate access to an interior of the storage compartment while in a released position. The storage compartment also includes an electromechanical actuator configured to transition the door between each position, and a sensor configured to emit a field, detect perturbations to the field, and generate a signal based on the perturbations. The storage compartment further includes a controller communicatively coupled to the electromechanical actuator and the sensor. The controller is configured to detect an object adjacent to the storage compartment based on the signal, and to instruct the electromechanical actuator to transition the door to the released position upon detection.

The present invention further relates to a storage compartment including a recess configured to receive a beverage container, and a securing feature configured to contact the beverage container while in an engaged position, and to release the beverage container while in a released position. The storage compartment also includes an electromechanical actuator configured to transition the securing feature between each position, and a sensor configured to generate a signal based on presence of an activating object. The storage compartment further includes a controller communicatively coupled to the electromechanical actuator and the sensor. The controller is configured to detect an object adjacent to the storage compartment based on the signal, and to instruct the electromechanical actuator to transition the securing feature to the released position upon detection.

### DRAWINGS

FIG. 1 is a perspective view of an exemplary vehicle that may include one or more sensor actuated storage compartments.

FIG. 2 is a perspective view of a part of the interior of the vehicle of FIG. 1.

FIG. 3 is a cross-sectional view of an overhead console, as shown in FIG. 2, including a sensor actuated storage compartment having a door in an engaged position.

FIG. 4 is a cross-sectional view of the overhead console, as shown in FIG. 3, with the door of the sensor actuated storage compartment in a released position.

FIG. 5 is a cross-sectional view of a sensor actuated cup holder, as shown in FIG. 2, including protrusions in an engaged position.

FIG. 6 is a cross-sectional view of the sensor actuated cup holder, as shown in FIG. 5, with the protrusions in a released position.

### DETAILED DESCRIPTION

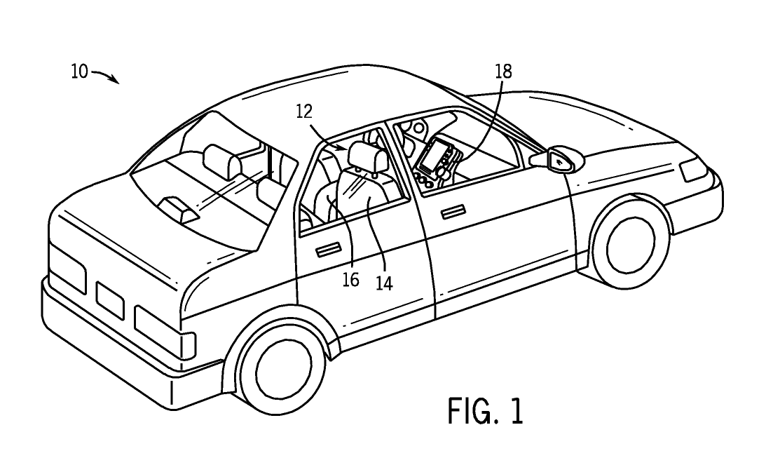

FIG. 1 is a perspective view of a motor vehicle 10 including one or more sensor actuated storage compartments in accordance with aspects of the present technique. As illustrated, the vehicle 10 includes an interior 12 having a seat 14, an armrest 16 and a center console 18. As discussed in detail below, the seat 14, armrest 16, center console 18 and/or other areas within the interior 12 may include storage compartments with securing features configured to selectively engage or release based on detection of an object adjacent to the compartment. For example, the armrest 16 may include a storage compartment having a door configured to substantially enclose the storage compartment while in an engaged position. The storage compartment may also include a sensor configured to detect the presence of an activating object (e.g., occupant hand) adjacent to the storage compartment. If the object is detected, a controller within the storage compartment may instruct an actuator to transition the door from the engaged position to a released position, thereby opening the door and facilitating access to an interior of the storage compartment. In this manner, when an occupant reaches toward a storage compartment, the compartment opens automatically without the occupant activating a physical release mechanism or electronic switch. Consequently, driver distraction may be substantially reduced or eliminated compared to configurations in which the driver must locate a physical switch (or mechanical handle or actuator). For example, because the driver may access the storage compartment without directly looking at it, the driver may maintain focus on the road. Furthermore, once the sensor has detected that the occupant hand has moved away from the storage compartment, the door may automatically reengage, thereby substantially enclosing the compartment.

The vehicle interior 12 may also include storage compartments configured to secure beverage containers. For example, the center console 18 may include cup holders that function in a similar manner to the storage compartments described above. Specifically, each cup holder may include a securing feature configured to block movement of a beverage container within the cup holder while in an engaged position. The cup holder may also include a sensor configured to detect the presence of an activating object (e.g., occupant hand) adjacent to the cup holder. If the object is detected, a controller within the cup holder may instruct an actuator to transition the securing feature from the engaged position to a released position, thereby facilitating removal of the beverage container from the cup holder. In this manner, when an occupant reaches toward a cup holder, the securing feature releases automatically without the occupant activating a physical release mechanism or electronic switch. Consequently, driver distraction may be substantially reduced or eliminated compared to configurations in which friction between the securing feature and the beverage container must be overcome to remove the beverage container from the cup holder. Conversely, after the occupant has placed a beverage container within the cup holder, the cup holder may automatically reengage the securing feature when the sensor detects that the occupant hand has moved away from the cup holder.

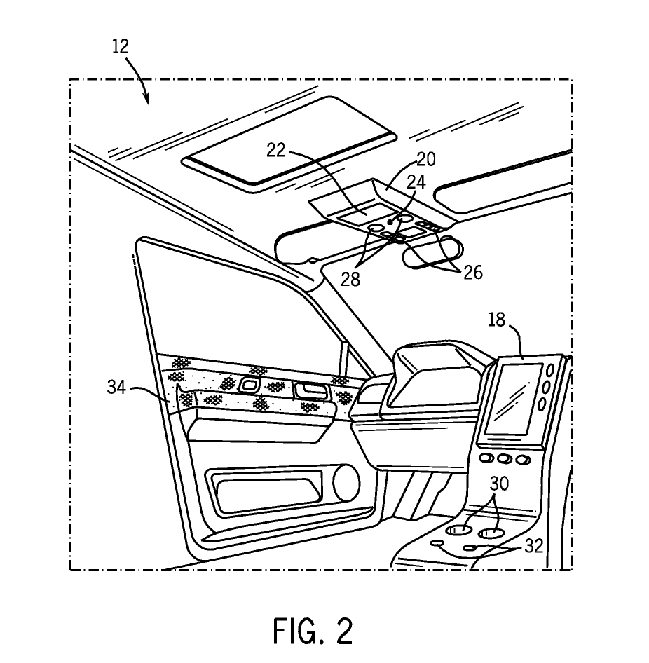

FIG. 2 is a perspective view of a part of the interior 12 of the vehicle 10 of FIG. 1. As illustrated, the vehicle interior 12 includes an overhead console 20 having a storage compartment 22, such as a bin for housing sunglasses. The overhead console 20 also includes a sensor 24 configured to actuate a door of the storage compartment 22. While the sensor 24 may be seen in the illustrated configuration, it will be appreciated that alternative embodiments may employ sensors 24 disposed behind a panel of the console 20 such that the sensors 24 are not visible to the vehicle occupants. As discussed in detail below, when an occupant reaches toward the storage compartment 22, the occupant hand will enter a detection range of the sensor 24. Once the occupant hand has been detected, the door of the storage compartment 22 will automatically open, thereby enabling the occupant to access the contents of the storage compartment 22 (e.g., sunglasses, coins, access cards, etc.). After the occupant hand has moved away from the storage compartment 22 (e.g., out of the detection range of the sensor 24), the storage compartment 22 will automatically close, thereby securing the contents of the compartment 22.

As illustrated, the overhead console 20 also includes various controls 26 and overhead lights 28. The controls 26 may be configured to operate various vehicle systems such as the overhead lights 28, ventilation systems, and/or HomeLink® by Johnson Controls. As will be appreciated, because these controls 26 are proximate to the sensor 24, the sensor 24 and/or a controller within the storage compartment 22 may be particularly configured to filter out hand movement toward the controls 26. For example, the range of the sensor 24 may be limited such that operation of the controls 26 does not cause the door of the compartment 22 to open. In certain embodiments, the sensor 24 may be configured to detect the angle and/or rate of approach of the hand toward the overhead console 20 to differentiate between accessing the controls 26 and reaching toward the storage compartment 22.

The vehicle interior 12 also includes the center console 18. As illustrated, the center console 18 includes cup holders 30 and sensors 32. Similar to the overhead storage compartment 22, the cup holders 30 are configured to selectively engage and release beverage containers based on a position of an occupant hand or other object (e.g., cup) relative to the cup holders 30. In the present configuration, each cup holder 30 includes a separate sensor 32 configured to actuate a particular cup holder 30. However, alternative embodiments may employ a single sensor 32 for actuation of both cup holders 32. Furthermore, while the sensors 32 are visible in the present embodiment, it should be appreciated that alternative embodiments may include sensors 32 disposed below a surface of the center console 18, such that the sensors 32 are not visible by occupants within the vehicle 10. As discussed in detail below, each cup holder 30 includes a securing feature configured to retain a beverage container within a recess of the cup holder 30. As an occupant reaches toward the cup holder 30, the sensor 32 detects the presence of the occupant hand and releases the securing feature, thereby enabling the occupant to remove the beverage container from the cup holder 30. Conversely, when the occupant hand moves away from the cup holder 30, the securing feature may reengage to block movement of the beverage container relative to the cup holder 30. Additional cup holders 30 and/or other storage compartments may be positioned throughout the vehicle interior 12, such as within the door panel 34.

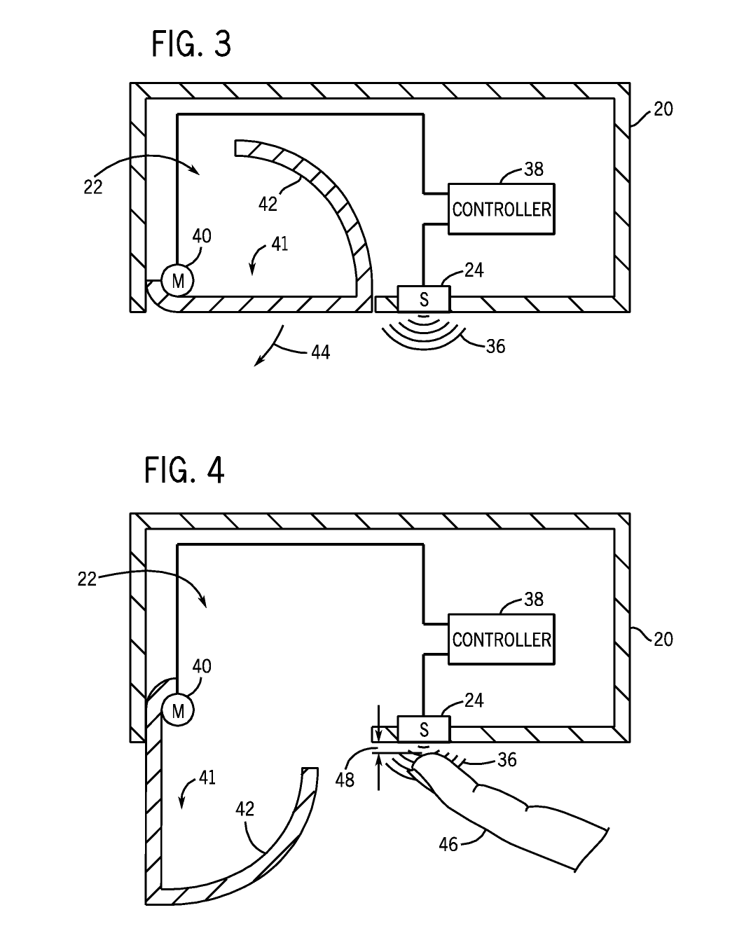

FIG. 3 is a cross-sectional view of the overhead console 20, as shown in FIG. 2, including a sensor actuated storage compartment 22 having a door in an engaged position. As previously discussed, the sensor 24 is configured to detect the presence of an activating object (e.g., an occupant hand, sunglasses, etc.) adjacent to the storage compartment 22. In certain configurations, the sensor 24 is configured to emit a field 36 and detect perturbations to the field. In this manner, the sensor 24 may detect the object even though the object does not contact the surface of the storage compartment 22. The range of the sensor 24 may be particularly selected based on the application. For example, as previously discussed, sensors 24 positioned proximate to other controls may be configured to have a shorter range than sensors 24 positioned in remote locations of the vehicle interior 12. As discussed in detail below, the range of the sensor 24 may also be selected such that the securing feature is completely released prior to the occupant hand reaching the storage compartment 22. In other words, the range of the sensor 24 may be sufficient to detect the presence of the hand at a distance that enables the door to open before the hand reaches the compartment 22. In alternative embodiments, the sensor 24 may be a touch sensitive switch configured to detect the presence of an object based on contact.

As will be appreciated, various sensors 24 may be employed to detect activating objects proximate to the storage compartment 22. For example, certain embodiments may employ a capacitance sensor which emits a field 36 to detect changes in the dielectric constant caused by any objects falling within the effective range of the field, such as due to the presence of an occupant hand adjacent to the storage compartment 22. Specifically, a controller 38 may provide the sensor 24 with a direct current (DC) or alternating current (AC) electrical signal. The sensor 24 is configured to convert this electrical signal into the field 36 that emanates from the surface of the storage compartment 22. The sensor 24 may then generate an output signal representative of the detected field. This signal may be received and analyzed by the controller 38 to determine whether an object is adjacent to the storage compartment 22. Alternative embodiments may employ a field effect type capacitance sensor which includes multiple plates to more accurately focus the field 36. Field effect sensors may provide greater precision, but lower range compared to traditional capacitance sensors.

Further embodiments may employ an ultrasonic transducer configured to emit and detect high frequency sound waves. Specifically, the controller 38 may provide the sensor 24 with a high frequency AC electrical pulse. The sensor 24 is configured to convert this electrical pulse into an acoustical field 36 that emanates from the surface of the storage compartment 22. For example, certain ultrasonic transducers utilize a piezoelectric ceramic disk to convert the high frequency AC pulse into an acoustical pulse that propagates away from the sensor 24. If the field 36 (i.e., acoustical pulse) impacts an object, the acoustical energy is reflected back to the sensor 24. The sensor 24 detects the reflected energy and generates an output signal representative of the detected field (i.e., returned acoustical energy). This signal may be received and analyzed by the controller 38 to determine whether an object is adjacent to the storage compartment 22.

Alternative embodiments may employ a radio frequency transducer configured to emit and detect electromagnetic waves. Similar to the ultrasonic transducer, the controller 38 may provide the sensor 24 with a high frequency AC electrical pulse. The sensor 24 is configured to convert this electrical pulse into an electromagnetic field 36 that emanates from the surface of the storage compartment 22. If the field 36 (i.e., electromagnetic pulse) impacts an object, the energy is reflected back to the sensor 24. The sensor 24 detects the reflected energy and generates an output signal representative of the detected field (i.e., returned electromagnetic energy). This signal may be received and analyzed by the controller 38 to determine whether an object is adjacent to the storage compartment 22.

Further embodiments may employ an optical transducer configured to emit and detect infrared, visible and/or ultraviolet light waves. The controller 38 may provide the sensor 24 with a DC current. The sensor 24 is configured to convert this electrical current into an optical field 36 that emanates from the surface of the storage compartment 22. If the field 36 (i.e., light rays) impacts an object, the energy is reflected back to the sensor 24. The sensor 24 detects the reflected energy and generates an output signal representative of the detected field (i.e., reflected light). This signal may be received and analyzed by the controller 38 to determine whether an object is adjacent to the storage compartment 22. For example, in certain embodiments, the controller 38 may compare the interference pattern between the transmitted light and the reflected light to determine a distance between the object and the sensor 24. Furthermore, the controller 38 may compare the frequency of the returned light to the frequency of the transmitted light to measure the Doppler shift, which may be utilized to determine the velocity of the object relative to the sensor 24. As will be appreciated, various other sensors (e.g., passive infrared, inductance, etc.) configured to detect the presence of an activating object may be employed in alternative embodiments.

Further embodiments may employ multiple sensors 24 to enhance the accuracy of object detection. For example, certain configurations may employ multiple optical transducers to triangulate the position of the object in three dimensions. Such configurations may enable the controller 38 to determine whether the occupant hand is reaching toward the controls 26 or the compartment 22 of the overhead console 20. Alternative embodiments may employ multiple sensors 24 of different types to ensure proper detection of the object. For example, certain embodiments may employ a capacitance sensor to determine whether an object is within the general area of the storage compartment 22. If an object is detected, the controller 38 may activate one or more optical transducers to accurately determine the position of the object. Such a configuration may reduce power consumption and/or occupant distraction that may be associated with continuous operation of an optical transducer. While the present embodiment includes a discrete controller 38 within the storage compartment 22, it should be appreciated that alternative embodiments may employ sensors 24 having integrated controllers. Alternatively, a vehicle controller positioned remote from the storage compartment 22 may be configured to receive the output signal from the sensor 24 and operate the actuator 40. It should be further appreciated that the controller 38 may include one or more solid state circuits and/or electromechanical relays, including controllers 38 that include only a single relay.

Once the controller 38 detects the presence of an object (e.g., occupant hand, sunglasses, etc.) adjacent to the storage compartment 22, the controller 38 will instruct an actuator, such as the illustrated electromechanical actuator 40, to transition the securing feature from an engaged position to a released position. As will be appreciated, alternative embodiments may include other actuator configurations, such as electromechanical latches, hydraulic actuators, pneumatic actuators, etc. In the present configuration, the securing feature is a door 41 configured to rotate from a closed (i.e., engaged) position to an open (i.e., released position). As illustrated, the door 41 includes a curved portion 42 configured to retain an item while the door 41 is in both the engaged and released positions. For example, an occupant may place a pair of sunglasses within the curved portion 42 of the door 41 while the door is in the open position. The sunglasses will be retained within the curved portion 42 even as the door 41 transitions to the closed position. When the controller 38 detects an object adjacent to the storage compartment 22, the door 41 will rotate in the direction 44 to facilitate access to any items within the storage compartment 22 and/or within the curved portion 42 of the door 41.

FIG. 4 is a cross-sectional view of the overhead console 20, as shown in FIG. 3, with the door of the sensor actuated storage compartment 22 in a released (i.e., open) position. As previously discussed, when an object, such as the illustrated occupant hand 46, enters the field 36, the sensor 24 will generate a signal corresponding to perturbations to the field 36. This signal will be transmitted to the controller 38 which will determine whether an object is positioned adjacent to the storage compartment 22. If such an object is detected, the controller 38 will instruct the actuator 40 to release the securing feature (e.g., rotate the door 41 to the open position).

In certain embodiments, the controller 38 may be configured to instruct the actuator 40 to open the door 41 only after certain predetermined conditions have been satisfied. For example, as previously discussed, the sensor 24 may be positioned adjacent to other controls within the overhead console 20. In such an environment, the controller 38 may be configured to detect an object adjacent to the storage compartment 22 only when the object is positioned a certain distance 48 from the sensor 24. Specifically, certain sensors 24 may be capable of detecting the object (e.g., the occupant hand 46) at a substantial distance from the sensor 24. However, if the controller 38 instructed the actuator 40 to open the door 41 immediately upon detection, the door 41 may open even though the occupant was reaching toward another area of the overhead console 20. As will be appreciated, such unintended actuation may be undesirable due to occupant distraction and/or confusion. Consequently, the controller 38 may be configured to instruct the actuator 40 to open the door 41 when the controller 38 detects that the object has entered a certain range 48, thereby ensuring proper functioning of the sensor actuated storage compartment 22. As will be appreciated, the particular range 48 may vary based on the arrangement of features within the overhead console 20. For example, in certain embodiments, the activation range 48 may be approximately between 1 to 40, 2 to 35, 3 to 30, 4 to 25, or about 5 to 20 cm.

In further embodiments, the controller 38 may be configured to detect the object adjacent to the storage compartment 22 based on other predetermined conditions. For example, certain sensors 24 may be capable of measuring the rate at which the object is approaching the sensor 24. For example, optical and/or radio frequency transducers may compare the transmitted frequency to the received frequency to measure a Doppler shift. As will be appreciated, the relative speed of an object may be computed based on the Doppler shift. Consequently, the controller 38 may be configured to compute the speed of the object relative to the sensor 24 to determine whether actuation of the door 41 is appropriate. For example, oscillations in velocity (e.g., movement toward and away from the sensor 24) may be indicative of occupant movement due to random vehicle motion, while a substantially consistent velocity toward the sensor 24 may be indicative of deliberate movement toward the storage compartment 22. Consequently, the controller 38 may be configured to only instruct the actuator 40 to release the door 41 when a sustained velocity toward the sensor 24 is computed. As will be appreciated, the controller 38 may include other predetermined conditions to enhance determination of whether the occupant is reaching toward the storage compartment 22.

Furthermore, the predetermined range 48, relative velocity and/or other parameters (e.g., sensor position, sensor angle, etc.) may be particularly configured to ensure that the door 41 is open prior to the occupant hand 46 reaching the storage compartment 22. Specifically, it may be desirable for an occupant to reach for the contents of the storage compartment 22 in one continuous movement, as compared to reaching for the compartment 22 and then stopping to wait for the compartment to open. Consequently, the controller 38 may be configured to instruct the actuator 40 to open the door 41 based on detected occupant hand position and/or relative velocity such that the door 41 is open before the occupant hand reaches the contents of the compartment 22. For example, the controller 38 may compute the approximate time required for the occupant hand to reach the storage compartment 22 based on the detected hand position and velocity. The controller 38 may compare the computed time to a predetermined time for opening the door 41. If the times are approximately equal, the controller 38 may instruct the actuator 40 to open the door 41. In this manner, the occupant may reach for the contents of the storage compartment 22 in one continuous movement.

As previously discussed, once the controller 38 no longer detects the presence of the object (e.g., occupant hand 46) adjacent to the storage compartment 22, the door 41 will automatically transition to the closed position. In alternative embodiments, the door 41 will close after a predetermined time delay. While the storage compartment 22 described above is positioned within the overhead console 20, it will be appreciated that additional sensor actuated storage compartments 22 may be positioned throughout the interior 12 of the vehicle 10. For example, such storage compartments may be located within the center console 18, the armrest 16, the seats 14, the door panels 34 and/or any other suitable location within the vehicle interior 12.

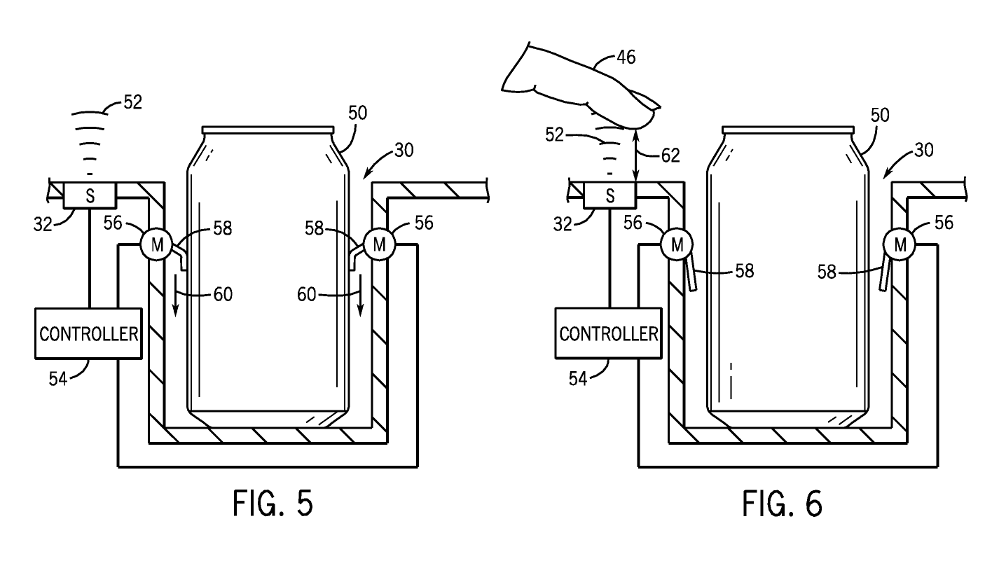

FIG. 5 is a cross-sectional view of a sensor actuated cup holder 30, as shown in FIG. 2, configured to operate in a similar manner to the storage compartment 22 described above. Specifically, the storage compartment 30 (e.g., cup holder) is configured to secure a beverage container, such as the illustrated soda can 50, within a recess. As will be appreciated, the cup holder 30 may be configured to accommodate a variety of beverage containers (e.g., water bottles, hot beverage mugs, paper cups, etc.) of varying size. Similar to the storage container 22 described above, the cup holder 30 includes a sensor 32 configured to detect the presence of an object (e.g., the occupant hand 46, beverage container, etc.) adjacent to the cup holder 30. In certain configurations, the sensor 32 is configured to emit a field 52 and detect perturbations to the field. In this manner, the sensor 32 may detect the object even though the object does not contact the surface of the cup holder 30. As previously discussed with regard to the storage compartment sensor 24, the range of the sensor 32 may be particularly selected based on the application. For example, the range of the sensor 32 may be sufficient to detect the presence of the hand 46 at a distance that enables the securing feature to release the beverage container 50 prior to the hand reaching the cup holder 30. In alternative embodiments, the sensor 32 may be a touch sensitive switch configured to detect the presence of an object based on contact. The sensor 32 may include any of the previously described sensors (i.e., capacitance sensor, field effect sensor, ultrasonic transducer, radio frequency transducer, or optical transducer), or any other sensor configuration capable of detecting an activating object adjacent to the cup holder 30. Furthermore, certain configurations may employ multiple sensors 32 to enhance the accuracy of object detection.

The sensor 32 is communicatively coupled to a controller 54 configured to both provide an input signal to the sensor 32 and receive an output signal from the sensor. Similar to the storage compartment controller 38, the controller 54 is configured to detect the presence of an object adjacent to the cup holder 30 and release a securing feature upon detection. In the present configuration, the securing feature includes any suitable mechanism for securing the beverage container 50 within the cup holder 30. The controller is communicatively coupled to an actuator, such as the illustrated electromechanical actuator 56, configured to selectively engage and release the securing feature. In the illustrated embodiment, the securing feature includes protrusions 58 configured to contact the beverage container 50. The protrusions 58 are resilient and configured to flex to accommodate various beverage container diameters. As illustrated, contact between the beverage container 50 and the protrusions 58 induces the protrusions to flex downwardly in the direction 60. As will be appreciated, such a configuration may facilitate securing beverage containers 50 having diameters substantially equal to the diameter of the cup holder 30 to diameters substantially equal to the maximum inward extent of the protrusions 58.

As illustrated, the protrusions 58 are oriented in the engaged position, i.e., contacting the beverage container 50 to secure the beverage container within the cup holder 30. Once the controller 54 detects the presence of an object (e.g., occupant hand 46, beverage container 50, etc.) adjacent to the cup holder 30, the controller 54 will instruct the actuators 56 to transition the protrusions 58 from the engaged position to a released position. Specifically, the actuators 56 will rotate the protrusions 58 in the direction 60. As will be appreciated, alternative embodiments may include other actuator configurations, such as electromechanical latches, hydraulic actuators, pneumatic actuators, etc. Furthermore, alternative embodiments may include other securing features such as retractable protrusions, clamps, or variable diameter strips that surround the beverage container 50, for example.

FIG. 6 is a cross-sectional view of the sensor actuated cup holder 30, as shown in FIG. 5, with the protrusions 58 in a released position. As previously discussed, when an object, such as the illustrated occupant hand 46, enters the field 52, the sensor 32 will generate a signal corresponding to perturbations to the field 52. This signal will be transmitted to the controller 54 which will determine whether an object is positioned adjacent to the cup holder 30. If such an object is detected, the controller 54 will instruct the actuators 56 to release the securing feature (e.g., rotate the protrusions 58 in the direction 60 toward the illustrated downward position). Similar to the storage compartment controller 38, the controller 54 may be configured to instruct the actuators 56 to release the protrusions 58 only after certain predetermined conditions have been satisfied. For example, the controller 54 may be configured to instruct the actuators 56 to release the protrusions 58 when the controller 54 detects that the object has entered a certain range 62, thereby ensuring proper functioning of the sensor actuated cup holder 30. Once the controller 54 no longer detects the presence of the object (e.g., occupant hand 46) adjacent to the cup holder 30, the controller 54 will automatically instruct the actuators 56 to transition the protrusions 58 to the engaged position. In alternative embodiments, the protrusions 58 may transition to the engaged position after a time delay. As will be appreciated, the sensor actuated cup holders 30 may be positioned throughout the interior 12 of the vehicle 10. In addition to the center console 18, cup holders 30, such as those described above, may be located within the armrest 16, the seats 14, the door panels 34, or any other suitable location within the interior 12.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A storage compartment, comprising:
a sensor configured to generate a signal based on presence of an activating object;
a controller communicatively coupled to the sensor and configured to detect an object adjacent to the storage compartment based on the signal; and
an actuator communicatively coupled to the controller and configured to release a securing feature of the storage compartment when the controller detects the object adjacent to the storage compartment.

2. The storage compartment of claim 1, wherein the sensor comprises a capacitance sensor, a field effect sensor, an ultrasonic transducer, a radio frequency transducer, an optical transducer, or a combination thereof.

3. The storage compartment of claim 1, wherein the actuator is configured to engage the securing feature of the storage compartment when the controller does not detect the object adjacent to the storage compartment.

4. The storage compartment of claim 1, wherein the actuator comprises an electromechanical actuator.

5. The storage compartment of claim 1, wherein the securing feature comprises a door configured to substantially enclose the storage compartment while in an engaged position, and to facilitate access to an interior of the storage compartment while in a released position.

6. The storage compartment of claim 1, wherein the securing feature comprises protrusions configured to contact a beverage container while in an engaged position, and to release the beverage container while in a released position.

7. The storage compartment of claim 1, wherein the object comprises a hand, an item within the hand, or a combination thereof.

8. The storage compartment of claim 1, wherein the sensor is configured to detect perturbations to a field at a range sufficient for the controller to detect the object without contact between the object and the storage compartment.

9. A storage compartment, comprising:
a door configured to substantially enclose the storage compartment while in an engaged position, and to facilitate access to an interior of the storage compartment while in a released position;
an electromechanical actuator configured to transition the door between each position;
a sensor configured to emit a field, detect perturbations to the field, and generate a signal based on the perturbations; and
a controller communicatively coupled to the electromechanical actuator and the sensor, wherein the controller is configured to detect an object adjacent to the storage compartment based on the signal, and to instruct the electromechanical actuator to transition the door to the released position upon detection.

10. The storage compartment of claim 9, wherein the controller is configured to instruct the electromechanical actuator to transition the door to the engaged position while the controller does not detect the object adjacent to the storage compartment.

11. The storage compartment of claim 9, wherein the sensor comprises a capacitance sensor, a field effect sensor, an ultrasonic transducer, a radio frequency transducer, an optical transducer, or a combination thereof.

12. The storage compartment of claim 9, wherein the door includes a curved portion configured to retain an item while the door is both in the engaged and released positions.

13. The storage compartment of claim 9, wherein the electromechanical actuator is configured to rotate the door between each position.

14. The storage compartment of claim 9, wherein the sensor is configured to detect perturbations to the field at a range sufficient for the controller to detect the object without contact between the object and the storage compartment.

15. A storage compartment, comprising:
a recess configured to receive a beverage container;
a securing feature configured to contact the beverage container while in an engaged position, and to release the beverage container while in a released position;
an electromechanical actuator configured to transition the securing feature between each position;
a sensor configured to generate a signal based upon presence of an activating object; and
a controller communicatively coupled to the electromechanical actuator and the sensor, wherein the controller is configured to detect an object adjacent to the storage compartment based on the signal, and to instruct the electromechanical actuator to transition the securing feature to the released position upon detection.

16. The storage compartment of claim 15, wherein the controller is configured to instruct the electromechanical actuator to transition the securing feature to the engaged position while the controller does not detect the object adjacent to the storage compartment.

17. The storage compartment of claim 15, wherein the sensor comprises a capacitance sensor, a field effect sensor, an ultrasonic transducer, a radio frequency transducer, an optical transducer, or a combination thereof.

18. The storage compartment of claim 15, wherein the securing feature comprises protrusions, and the electromechanical actuator is configured to rotate the protrusions between each position.

19. The storage compartment of claim 18, wherein the protrusions are resilient and configured to flex to accommodate various beverage container diameters.

20. The storage compartment of claim 15, wherein the sensor is configured to detect perturbations to a field at a range sufficient for the controller to detect the object without contact between the object and the storage compartment.
